(19) United States
(12) Patent Application Publication
(10) Pub. No.: US 2017/0235724 A1
(43) Pub. Date: Aug. 17, 2017

(54) SYSTEMS AND METHODS FOR GENERATING PERSONALIZED LANGUAGE MODELS AND TRANSLATION USING THE SAME

(71) Applicant: Emily Grewal, New Haven, CT (US)

(72) Inventor: Emily Grewal, New Haven, CT (US)

(21) Appl. No.: 15/428,227

(22) Filed: Feb. 9, 2017

Related U.S. Application Data
(60) Provisional application No. 62/294,180, filed on Feb. 11, 2016.

(51) Int. Cl. G06F 17/28; G06F 17/27

(52) U.S. Cl. CPC G06F 17/2881; G06F 17/274

(57) ABSTRACT

A method for generating a personalized language model using a language translation (LT) computing device is provided. The method includes collecting, by the LT computing device, a plurality of communications from at least one data source in network communication with the LT computing device, coding the collected plurality of communications based on dimensions of the collected communications, determining a style of communication from the plurality of communications based on each dimension, and populating a data structure corresponding to the personalized language model with the dimensions and style of communication.

### CROSS REFERENCE TO RELATED APPLICATIONS

This application claims the priority of Provisional Patent Application Ser. No. 62/294,180, filed Feb. 11, 2016, which is hereby incorporated by reference in its entirety.

### BACKGROUND OF THE DISCLOSURE

The field of the invention relates generally to enabling electronic communication between two or more parties, and, more specifically, to network-based systems and methods for electronically translating communication from one party and delivering a translated communication to a second party.

Consumers of communications systems increasingly desire enhanced communications. They send and receive communications using a variety of services and systems such as e-mail, messaging applications, video sharing services, and other communications channels. Consumers are increasingly communicating using digital communications systems. This communication includes standard communication, such as grammatically correct sentences, full sentences, correct spelling, etc., and non-standard communication. For example, consumers communicate using abbreviations, non-alphabetic symbols, colloquialisms, non-punctuated sentences, non-standard punctuation, and other non-standard language. For recipients of standard or non-standard communication it is often difficult to understand the communication and the ideas conveyed by the communication either because of differences in standard language usage between the parties and/or because of non-standard language. Known systems do not address the use of non-standard language and differences in language understanding between parties in communications which inhibit understanding of those communications.

Accordingly, it is desired to have a system that will automatically evaluate communications and alter the communications to enhance the ability of recipients to understand the communications.

### BRIEF DESCRIPTION OF THE DISCLOSURE

In one aspect, a method for generating a personalized language model using a language translation (LT) computing device is provided. The method includes collecting, by the LT computing device, a plurality of communications from at least one data source in network communication with the LT computing device, coding the collected plurality of communications based on dimensions of the collected communications, determining a style of communication from the plurality of communications based on each dimension, and populating a data structure corresponding to the personalized language model with the dimensions and style of communication.

In another aspect, a method for translating a communication using a personalized language model, and using a language translation (LT) computing device is provided. The method includes collecting, by the LT computing device, a plurality of communications from at least one data source in network communication with the LT computing device, the plurality of communications associated with a second user, coding the collected plurality of communications based on dimensions of the collected communications, generating the personalized language model corresponding to the second user based on the dimensions, generating equivalency information for at least one of the dimensions, receiving the communication, by the LT computing device, from a first user device corresponding to a first user, the user device in network communication with the LT computing device, determining whether to replace at least one element of the communication with a new element based on the personalized language model corresponding to the second user and the equivalency information, and transmitting, by the LT computing device, the communication to a second user device, the second user device in network communication with the LT computing device.

In yet another aspect, a language translation (LT) computing device for translating a communication using a personalized language model is provided. The LT computing device includes a processor, and a memory coupled to the processor. The processor is configured to collect a plurality of communications from at least one data source in network communication with the LT computing device, the plurality of communications associated with a second user, code the collected plurality of communications based on dimensions of the collected communications, generate the personalized language model corresponding to the second user based on the dimensions, generate equivalency information for at least one of the dimensions, receive the communication from a first user device corresponding to a first user, determine whether to replace at least one element of the communication with a new element based on the personalized language model corresponding to the second user and the equivalency information, and transmit the communication to a second user device.

### BRIEF DESCRIPTION OF THE DRAWINGS

FIGS. 1-3 show example embodiments of the methods and systems described herein.

FIG. 1 is a schematic diagram illustrating a language translation (LT) computing device in a communication system, the LT computing device for collecting communications, generating personalized language models (PLMs) based on the collected communications, translating communications based on the PLMs, and transmitting the translated communications in accordance with one embodiment of the present disclosure.

FIG. 2 is a simplified diagram of an example method of collecting communications, generating PLMs based on the collected communications, translating communications based on the PLMs, and transmitting the translated communications using the LT computing device of FIG. 1.

FIG. 3 is a diagram of components of one or more example LT computing devices used in the environment shown in FIG. 1.

### DETAILED DESCRIPTION OF THE DISCLOSURE

The following detailed description illustrates embodiments of the disclosure by way of example and not by way of limitation.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The technical effects of the systems and methods described herein include at least one of: (a) automatically collecting written or verbal communications from a data source; (b) coding the collected communications based on dimensions of the collected characteristics; (c) generating a personalized language model for at least one user based on the coded communications; and (d) generating equivalency information for the personalized language model. The technical effects of the systems and methods described herein further include: (e) automatically receiving a first communication from a first user; (f) automatically translating the first communication using at least one of the personalized language model and the equivalency information; and (g) automatically transmitting the translated communication to a second user indicated in the first message as the recipient.

The systems and methods described herein include a language translation (LT) computing device that is configured to alter a communication to enhance the ability of a recipient to understand the communication. The LT computing device automatically alters the communication. In alternative embodiments, the LT computing device alters communications when a user has opted in to a system including the LT computing device and/or provides options to the user for selection or approval prior to altering the communication. The LT computing device includes a processor in communication with a memory. The LT computing device is in network communication with two or more user devices. A first user, using a first user device, sends a communication to a second user who receives the communication using a second user device. As used herein, each of the first and second users may be an individual or a group. The group may be, for example, associated with a company, associated with a particular literary style (e.g., Shakespeare), associated with a particular book, associated with a particular character, associated with a particular person, etc. The LT computing device first receives the communication from the first user device. The LT computing device alters the communication using a translation process. The LT computing device translates the communication using a personalized language model (PLM) corresponding with the first user and/or second user, and equivalency information. The PLM(s) are generated based on collected communications corresponding to the users. The PLM(s) may be further based on a comparison of a user to another group of users sharing similar characteristics. The LT computing device then transmits the altered, translated, communication to the second user device.

### Data Collection Phase

The LT computing device is in network or other electronic communication with data sources. The LT computing device collects communications from the first user to generate a PLM corresponding to the first user. For example, the LT computing device collects communications from the data sources using a communications interface configured to allow for networked communication. In some embodiments, the LT computing device collects communications addressed to a plurality of different audiences. The LT computing device uses this information to generate PLMs for a user specific to different audiences the user communicates with. Data sources may be publicly available data sources or privately available data sources. Data sources include electronically accessible communications of the first user and other parties. Public data sources include social media communications, news articles, scholarly articles, books, websites, and/or other public written material. For example, public data sources include Twitter® posts, Facebook® posts (to friends or public), LinkedIn®, articles written for newspapers or journals like Business Insider® or New York Times®, scholarly articles written in publications like Science, books, magazines, or other sources of published written material. Private data sources include non-public social media communications, e-mail, text messages sent between mobile phones (e.g., using the Short Message Service), and/or other non-public written material. For example, private data sources include e-mail sent or stored using a personal e-mail account with an e-mail provider, e-mail sent or stored using a professional e-mail account (e.g., an employer provided e-mail account) with an e-mail provider, Facebook® messages, text messages, WhatsApp® messages, Snapchat® text, and/or other source of written communication. Retrieved communications from the one or more data sources are stored in a database accessible by the LT computing device.

In further embodiments, the LT computing device is further in network communication with data sources which include verbal communications. These data sources may be publicly available or privately available. Data sources including verbal communications may include electronically available videos, electronically available audio recordings, telephone calls, or other sources of verbal communication. For example, data sources may include phone calls on a personal cell phone, phone calls on an employer provided cell phone, TED® talks, YouTube® videos where there is speech, and/or other verbal communications.

In further embodiments, data sources include public or private communications, written or verbal, which are not electronically accessible. For example, data sources may include print newspaper, letters, print diaries, physical audio and/or visual recordings, and/or other data sources which are not capable of or otherwise not in network communication with the LT computing device.

### Coding Phase

Based on the collected communications stored in the database of the LT computing device, the LT computing device analyzes the communications of each party to code the communications on a variety of dimensions and characteristics. The analysis is performed using one or more algorithms, functions, and/or programs stored in memory and executed by a processor. For example, verbal communication may be transcribing using a voice to text algorithm, written communication may be analyzed using natural language processing or structured language processing algorithms, written communication may be coded using algorithms that operate based on one or more word lists, verbal communication may be coded using pitch and tone analyzing algorithms, and/or other algorithms, programs, or functions may be used to code collected communications. Collected communications are coded on a plurality of dimensions and/or characteristics. For example, the collected communications, written and/or verbal, are coded based on the type of words included in the communication (e.g., parts of speech, tense, length of words, etc.), the punctuation, the grammar, phrases (e.g., common phrases, greetings, colloquialisms, etc.), categories of words (e.g., negation words, sign-offs, sign-ons, etc.), length of text, structure of text including the number of paragraphs and spacing, the use of emoticons, the use of emojis, difficulty or complexity of words, length of words, purpose of the communication, and/or other dimensions or characteristics. In some embodiments, collected communications, verbal and/or written, are further coded based on dimension and characteristics including length of speech, tone, pace, intonation, pitch, frequency, changes in pitch, changes in pace, changes in tone, changes in any other dimension, verbal emphasis on specific words. The purpose of collected communications can be specified or inferred based on the other coded dimensions or characteristics. For example, the purpose of the communication may be identified as a request based on specific words/phrases associated with a request (e.g., please, do, complete, track down, prepare, etc.).

Information corresponding to the coded collected communications is stored in the database of the LT computing device. For example, a database contains the coded information stored along with the original communications and/or an identifier of the author of the collected communication.

### PLM Generation Phase

The LT computing device generates a PLM for each user or group for which corresponding collected and coded communications exist. The LT computing device generates the PLM using one or more algorithms, functions, or programs stored in memory and executed by a processor. The LT computing device generates the PLM based on the coded communications. The PLM is a predictive model of how an individual user associated with the PLM writes and/or speaks. In other words, the PLM is a predictive model of the style of an author/speaker, or a group with which the author/speaker is associated. The PLM predicts the dimensions of communication coded in the Coding Phase. For example, the PLM predicts the frequency of dimensions and characteristics in a user's communications such as type of words included in the communication, punctuation, grammar, phrases, categories of words, length of text, structure of text including the number of paragraphs and spacing, the use of emoticons, the use of emojis, difficulty or complexity of words, length of words, purpose of the communication, length of speech, tone, pace, intonation, pitch, frequency, changes in pitch, changes in pace, changes in tone, changes in any other dimension, verbal emphasis on specific words, and/or other dimensions or characteristics. In some embodiments, the PLM corresponding to an author (e.g., user, sender, or recipient) is a table of dimensions and/or characteristics of communication and the corresponding frequency with which the author's communications include or exhibit the dimensions and/or characteristics. The PLM may take into account dimensions and/or characteristics beyond the frequency of element occurrence. For example, the PLM may take into account the person or group to whom the user is communicating. The PLMs generated for a user may be audience specific. The PLM(s) are stored in the database of the LT computing device.

In some embodiments, The PLM will be recipient user specific (e.g., the second user). For example, the LT computing device may generate a series of PLMs for each user, with each PLM corresponding to communication between that user and a particular second user. The PLM accounts for the relationship between the first user sending the communication and the second user receiving the communication. The relationship is defined by factors such as closeness, relative power, and social connections like Facebook®, or other social media, mutual friends, the number of communications between the two users, and the actual social connection such as boss or father. The relationship can also be inferred by comparing prior communication between the first user sending the communication and the second user receiving the communication to other communications by the first user to different communication recipients and grouping the communication with similar communications. In further embodiments, the PLM incorporates data on factors that might affect how an individual writes or speaks—time specific factors such as time of day or day of week, or demographic specific factors such as age or gender, and emotional state factors such as if the user is depressed or not. In further embodiments, the PLM accounts for the communication to which that the individual is responding. In still further embodiments, the PLM incorporates data on projected changes to different dimensions of language based on prior PLM data or by comparing PLMs from different people and looking at changes from similar PLMs.

### Equivalency Generation Phase

The LT computing device generates equivalency information for each dimension predicted by the PLM. Equivalency information maps out alternative values of each element or dimension predicted by the PLM. For example, an equivalent to an exclamation point could be a period, no punctuation, an emoticon or an emoji as those are what someone might employ instead of an exclamation point. The equivalency information may be generated using a variety of manual and/or automatic techniques or processes. For example, an algorithm, program, or function stored in memory and when executed by a processor is configured to generate the equivalency information based on or otherwise using the collected communications and the PLMs. For example, the LT computing device may compare similar answers to the same question or other similar dimensions or characteristics across a plurality of communications and PLMs to determine equivalent words, phrases, punctuation, styles, or other dimensions and characteristics. The LT computing device may use natural language processing, structured language processing, machine learning, and/or other algorithms or techniques to detect equivalencies and generate equivalency information. The equivalency information is stored in the database of the LT computing device. For example, the equivalency data is stored as a table or other data structure correlating words, phrases, or other elements with identified equivalents.

### Translation Phase

The LT computing device receives a communication from a first user directed to a second user, or group of users, and translates the communication based on the PLMs (e.g., of the first and/or second user) and equivalency information and transmits the translated communication to the second user. The LT computing device uses algorithms, functions, and/or programs stored in memory and executed by a processor to perform these functions. In the translation process, the LT computing device translates the communication from the sender's PLM to the recipient's PLM so that the language the recipient receives is translated into their PLM. The translated communication is substantially how a recipient would write or say what the sender is saying. In other words, the LT computing device translates a communication from the first user which reflects the style predicted by the first user's PLM into a communication which reflects the style of the second user predicted by the second user's PLM. The equivalency information is used to perform the translation. For example, the equivalency information is used to identify a word of phrase in the first user's PLM and a corresponding word or phrase having substantially the same meaning in the second user's PLM. This word or phrase found in the second user's PLM which maintains the meaning of the communication is substituted for the original word or phrase in the communication. The LT computing device may store the communication to be translated in memory and query the database to retrieve equivalency information and PLMs (e.g., the PLM of the recipient). Using the equivalency information, the LT computing device substitutes elements of the received communication with equivalents which correspond to frequently used elements in the PLM of the recipient. The resulting translated communication is stored in memory. The resulting translated communication is transmitted to the recipient identified in the original communication by the LT computing device using the communication interface and network. In some situations, the original communication may already match the style of the second user, and no translation is performed.

If no input is available from the sender (e.g., first user) and the sender is seeking to communicate with a recipient (e.g., second user) either as a reply or an initial contact, the language of the translated communication will be generated using the recipient's PLM. For example, no equivalency information is used in the translation. In alternative embodiments, equivalency information for a general (e.g., average user) PLM and the recipient's PLM is used in the translation. Further, the general PLM used may be determined based on demographic information of the sender. For example the general PLM may be determined based on a gender, age, personality type, and/or residence of the sender. Accordingly, a general PLM used for a first sender may be different than a general PLM used for a second sender. Using a general PLM, the language generated is substantially what the recipient would have written in that situation. Language generation using this process allows for communication to be translated when the LT computing device lacks sufficient data to generate a PLM of the sender.

If the recipient of a communication is a group of individuals and personalization cannot happen, then the communication will be translated and/or language generation will occur (e.g., be performed by the LT computing device) on an objective function and maximizing that objective function. For example, if the objective function is to get the most people to buy a product, the system will analyze to see who is most likely to pay and then weight the translation or language generation to the PLMs of users identified as more likely to pay or purchase the product.

Translation and language generation can be performed before the intended communication is taking place, in real time, or any time before the communication is received. Translation and language generation can be performed on a mobile device, computer, in person, or on any other technology that can communicate (e.g., an Amazon® Echo®, a talking robot, a car navigation system, etc.).

The LT computing device may be used for a plurality of communication applications to enhance communication between users. The translation and/or language generation process results in communication which is more readily understood by recipients of the communication. For example, translation and/or language generation can be used for one to one communication including phone calls, text messages, Facebook® messages, in person talking, talking using virtual reality products, communication in online games, WhatsApp® messages, or other communication. Translation and/or language generation can be used for communication between one and a plurality of users including Facebook® posts, articles in newspapers or online blogs, political speeches, presentations in a work context, TED® talks, or Twitter® posts. Translation and/or language generation can be used for advertisements in personalizing the ad copy or speech. Translation and/or language generation can be used by products communicating with individuals or groups such as any artificial intelligence (e.g., Amazon® Echo®, Apple® Siri®, etc.), an online greeting card, or the text on a website. Translation and/or language generation can be used by businesses or entities communicating with individuals using communication including emails for political campaigns, marketing emails, online courses, recruiting correspondences, or job postings. Translation and/or language generation can be used for cultural purposes to help cross-cultural communication where PLMs can be different on average for members of different cultures. Translation and/or language generation can be used for high-stakes relationships where the cost of miscommunication can be high such as a doctor and patient relationship. Translation and/or language generation can be used for recruiting purposes to customize job postings and any correspondence between a recruiter/company and the potential employees.

In some embodiments, the LT computing device provides suggested edits to a communication drafted by a first user for receipt by a second user. For example, the user may send a communication to the LT computing device. Using at least one PLM (e.g., of the first and/or second user), the LT computing device analyzes the communication and may generate at least one suggested edit for the communication (unless the LT computing device determines the communication is suitable as is). For example, the LT computing device may provide a suggested edit that recommends replacing a word in the communication with a new word. Any suggested edits are provided to the first user, so that the first user can incorporate any suggested edits (if desired) before sending the communication to the second user. Thus, in such embodiments, the LT computing device assists the first user in editing the communication to better match the style of the second user.

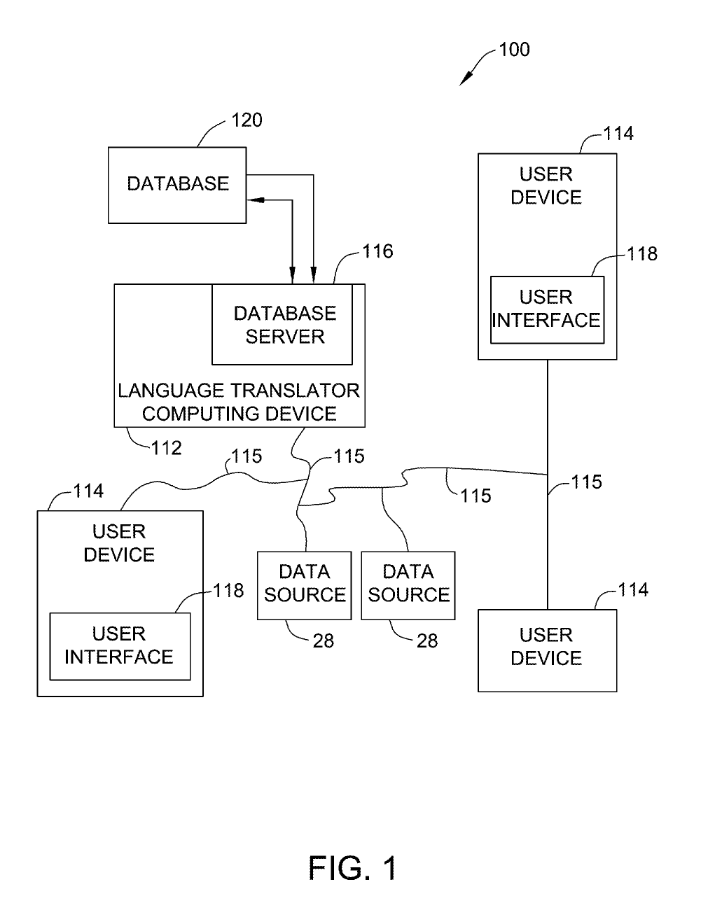

Referring now to FIGS. 1-3, in one embodiment, a computer program is provided which is executed by the LT computing device, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

FIG. 1 is a schematic diagram illustrating a LT computing device 112 in a communication system 100 in accordance with one embodiment of the present disclosure. The LT computing devices 112 is configured to collect communications from data source(s) 28, generate PLMs based on the collected communications, translate communications based on the PLMs, and transmit the translated communications to one or more user devices 114.

More specifically, in the example embodiment, communication system 100 includes an LT computing device 112, and a plurality of client sub-systems, also referred to as user devices 114, connected to LT computing device 112. In one embodiment, user devices 114 are computers including a web browser, such that LT computing device 112 is accessible to user devices 114 using the Internet and/or using network 115. User devices 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. User devices 114 may include systems associated with users of LT computing device 112 as well as external systems used to store data. LT computing device 112 is also in communication with data sources 28 using network 115. Further, user devices 114 may additionally communicate with data sources 28 using network 115. User devices 114 could be any device capable of interconnecting to the Internet including a web-based phone, PDA, computer, or other web-based connectable equipment.

In one embodiment, database 120 is stored on LT computing device 112. In an alternative embodiment, database 120 is stored remotely from LT computing device 112 and may be non-centralized. Database 120 may be a database configured to store information used by LT computing device 112 including, for example, collected communications, a database of coded communications, a database of PLMs corresponding to a plurality of users, equivalency information, communications transmitted between users of LT computing device 112, translated communications between users of LT computing device 112, user information, and/or other information. Database 120 may include a single database having separated sections or partitions, or may include multiple databases, each being separate from each other.

In the example embodiment, one of user devices 114 may be associated with a first user and one of user devices 114 may be associated with a second user. For example, a first user may transmit a communication from user device 114 to a second user. The communication is first received by LT computing device 112 and translated. The LT computing device then transmits the translated communication to the second user identified in the communication transmitted from the first user. The second user receives the translated communication using a user device 114. In the example embodiment, one or more of user devices 114 includes a user interface 118. For example, user interface 118 may include a graphical user interface with interactive functionality, such that communications transmitted from LT computing device 112 to user device 114 may be shown in a graphical format and communications may be generated by users. A user of user device 114 may interact with user interface 118 to view, explore, and otherwise interact with LT computing device 112. For example, a user may enroll with LT computing device 112 such that communications are translated, and may provide user information such as preferences, communications for data collection, and/or other information. User devices 114 also enable communications to be transmitted and/or received using data sources 28. These communications may be retrieved from data sources 28 through network 115 by LT computing device 112 for use in coding communications, generating PLMs, generating equivalency information, translating communications, and/or other functions described herein.

In some embodiments, LT computing device 112 further includes an enrollment component for enrolling users with LT computing device 112. Enrollment data (e.g., initial username, initial password, communications for data collection, etc.) is transmitted by user device 114 to LT computing device 112. For example, a user may access a webpage hosted by LT computing device 112 and access an application running on user device 114 to generate enrollment login information (e.g., username and password) and transmit the enrollment information to LT computing device 112. LT computing device 112 stores the received login information data in a database of login information (e.g., in database 120) along with collected communications (e.g., provided by the user or collected from data sources 28 based on user identity information provided by the user).

User device 114 may provide inputs to LT computing device 112 via network 115 which are used by LT computing device 112 to execute the functions described herein. For example, user device 114 provides messages for translation and transmission to a second user or group of users along with instructions to translate the message. User device 114 may include a program or application running thereon which provides for communication of instructions (e.g., translation parameters) messages/communications for translation, identification of recipients of the translated communication, and/or other functions.

LT computing device 112 includes a processor for executing instructions. Instructions may be stored in a memory area, for example, and/or received from other sources such as user device 114. The processor may include one or more processing units (e.g., in a multi-core configuration) for executing instructions. The instructions may be executed within a variety of different operating systems of LT computing device 112, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

The processor is operatively coupled to a communication interface such that LT computing device 112 is capable of communicating with a remote device such as a user device 114, database 120, data sources 28, and/or other systems. For example, the communication interface may receive requests from a user device 114 via the Internet or other network 115, as illustrated in FIG. 1.

Processor may also be operatively coupled to a storage device. The storage device is any computer-operated hardware suitable for storing and/or retrieving data. In some embodiments, the storage device is integrated in the LT computing device 112. For example, LT computing device 112 may include one or more hard disk drives as a storage device. In other embodiments, the storage device is external to LT computing device 112 and may be accessed by a plurality of LT computing devices 112. For example, the storage device may include multiple storage units such as hard disks or solid state disks in a redundant array of inexpensive disks (RAID) configuration. The storage device may include a storage area network (SAN) and/or a network attached storage (NAS) system. In some embodiments, LT computing device 112 also includes database server 116.

In some embodiments, the processor is operatively coupled to the storage device via a storage interface. The storage interface is any component capable of providing the processor with access to the storage device. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor with access to the storage device.

The memory area may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program. The memory area further includes computer executable instructions for performing the functions of the LT computing device 112 described herein.

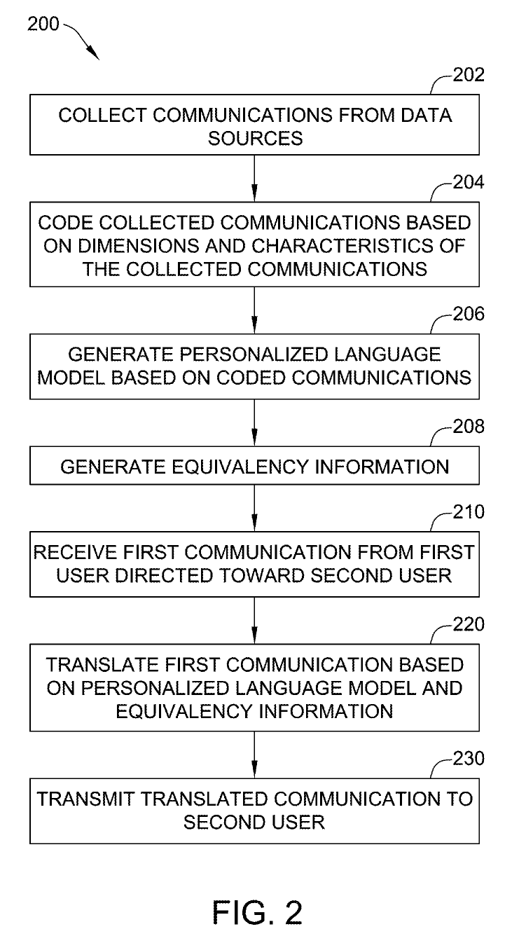

FIG. 2 is a simplified diagram of an example method 200 for translating communications between users using the LT computing device of FIG. 1. The LT computing device collects 202 communications from at least one data source. The LT computing device codes 204 the collected communications based on dimensions and/or characteristics of the collected communications. The LT computing device generates 206 at least one PLM based on the coded communications. The LT computing device generates 208 equivalency information corresponding to at least one user, at least one recipient, and/or at least one PLM. The LT computing device receives 210 a first communication for a first user, the first communication directed towards a second user or other recipient. The LT computing device translates 220 the first communication based on at least one of equivalency information, a PLM associated with the first user, and/or a PLM associated with the second user or other recipient. In some embodiments, the LT computing device identifies the recipient(s) of the first communication and selects a PLM of the first user which corresponds to the audience which includes the recipient(s) of the first communication. The LT computing device transmits 230 the translated communication to the second user or other recipient specified by the first user. In alternative embodiments, the LT computing device does not generate equivalency information and does not use equivalency information in translating a communication. For example, if a computer program, application, artificial intelligence, or other software is communication with party, the LT computing device uses the PLM associated with the party to generate the communication. This allows the LT computing device to tailor communications to specific recipients.

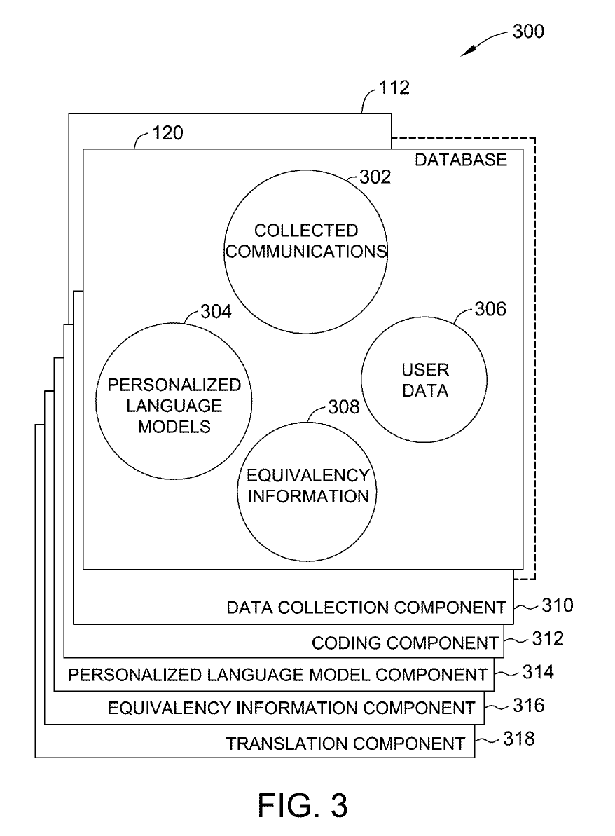

FIG. 3 is a diagram of components 300 of one or more example computing devices that may be used in the environment shown in FIG. 1. Database 120 may store information such as, for example, collected communications 302, PLMs 304, user data 306, equivalency information 308, and/or other data. Database 120 is coupled to several separate components within LT computing device 112, which perform specific tasks.

LT computing device 112 includes a data collecting component 310 for collecting communications from data sources 28, as described above. Coding component 312 is used to code the collected communications based on the dimensions and characteristics of the communications. Coding component 312 uses language processing algorithms, functions, and/or programs stored in memory and executed by a processor of LT computing device 112 to analyze the collected communications and store associated information in database 120 of coded communications, as described above. PLM component 314 is used to generate PLMs based on the coded collected communications.

PLM component 314 uses algorithms, functions, and/or programs stored in memory and executed by a processor of LT computing device 112 to generate the PLMs, as described above. For example, PLM component 314 uses identification information (e.g., a name, user account, etc.) to identify all collected and coded communications stored in database 120 from a particular party. PLM component 314 uses the associated information describing the dimensions and characteristics of the aggregate of the coded communications to build a PLM which predicts and/or describes the frequency with which the party will communicate using the coded dimensions and/or characteristics. For example, the PLM includes information regarding the frequency with which the party uses each of the coded dimensions and/or characteristics in their communications. The PLMs are stored in database 120.

Equivalency information component 316 is used by LT computing device 112 to generate equivalency information, as described above. Equivalency information component 316 uses algorithms, functions, and/or programs stored in memory and executed by a processor of LT computing device 112 to generate the equivalency information.

Translation component 318 is used by LT computing device 112 to translate communications using one or more PLMs, equivalency information, and/or other information, as described above. Translation component 318 uses algorithms, functions, and/or programs stored in memory and executed by a processor of LT computing device 112 to translate communications. LT computing device 112 receives communications for translation using a communication interface. The communications are transmitted by a user device 114. For example, LT computing device uses a PLM and/or equivalency information to replace words and/or phrases of the received communication with equivalent words and/or phrases such that the resulting text resembles or includes words and/or phrases or other style components frequently used by the recipient of the communication or otherwise predicted to be used by the recipient of the communication. For example, the LT computing device may infer content for a translated communication based on the author's communication history and/or by extrapolating a PLM of a user sharing similar characteristics to the PLM of the author or to the author themselves (e.g., age, gender, residence location, etc.). The frequency is determined based on the PLM of the recipient. LT computing device 112 uses the communications interface to transmit the translated message to the recipients of the communication indicated by the communication transmitted by the sender.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The above-described systems and methods enable allocating a minimum percentage of peak bandwidth to a priority class. More specifically, the systems and methods described herein provide determine peak bandwidth demand and allocate a minimum percentage of the peak bandwidth demand to a priority class.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for generating a personalized language model using a language translation (LT) computing device, said method comprising:
collecting, by the LT computing device, a plurality of communications from at least one data source in network communication with the LT computing device;
coding the collected plurality of communications based on dimensions of the collected communications;
determining a style of communication from the plurality of communications based on each dimension; and
populating a data structure corresponding to the personalized language model with the dimensions and style of communication.

2. The method of claim 1, wherein determining a style of communication comprises determining an occurrence of each dimension within the plurality of communications corresponding to each dimension.

3. The method of claim 1 further comprising identifying an audience of at least one of the plurality of communications, wherein the data structure identifies the audience.

4. The method of claim 1, further comprising identifying a similar user and extrapolating coded collected communications of the similar user to determine the style of communication.

5. The method of claim 1, wherein coding the collected plurality of communications comprises coding the collected plurality of communications based on at least one of word type, punctuation, grammar, and word categories in the plurality of communications.

6. The method of claim 1, further comprising:
receiving a communication from a user device;
analyzing the communication based on the personalized language model to determine whether there are any suggested edits to the communication; and
transmitting any suggested edits to the user device.

7. A method for translating a communication using a personalized language model, and using a language translation (LT) computing device, said method comprising:
collecting, by the LT computing device, a plurality of communications from at least one data source in network communication with the LT computing device, the plurality of communications associated with a second user;
coding the collected plurality of communications based on dimensions of the collected communications;
generating the personalized language model corresponding to the second user based on the dimensions;
generating equivalency information for at least one of the dimensions;
receiving the communication, by the LT computing device, from a first user device corresponding to a first user, the user device in network communication with the LT computing device;
determining whether to replace at least one element of the communication with a new element based on the personalized language model corresponding to the second user and the equivalency information; and
transmitting, by the LT computing device, the communication to a second user device, the second user device in network communication with the LT computing device.

8. The method of claim 7, wherein transmitting the communication to a second user device comprises transmitting the communication to a second user device corresponding to the second user.

9. The method of claim 7, further comprising determining an occurrence within the plurality of communications corresponding to each dimension.

10. The method of claim 9, wherein generating the personalized language model further comprises generating the personalized language model based on the corresponding occurrence of each dimension;

11. The method of claim 7, wherein the communication is an advertisement.

12. The method of claim 7, wherein coding the collected plurality of communications comprises coding the collected plurality of communications based on at least one of word type, punctuation, grammar, and word categories in the plurality of communications.

13. The method of claim 7, wherein coding the collected plurality of communications comprises coding the collected plurality of communications based on at least one of word complexity, word length, text length, and text structure in the plurality of communications.

14. A language translation (LT) computing device for translating a communication using a personalized language model, the LT computing device comprising:
a processor; and
a memory coupled to said processor, said processor configured to:
collect a plurality of communications from at least one data source in network communication with the LT computing device, the plurality of communications associated with a second user;
code the collected plurality of communications based on dimensions of the collected communications;
generate the personalized language model corresponding to the second user based on the dimensions;
generate equivalency information for at least one of the dimensions;
receive the communication from a first user device corresponding to a first user;
determine whether to replace at least one element of the communication with a new element based on the personalized language model corresponding to the second user and the equivalency information; and
transmit the communication to a second user device.

15. The LT computing device of claim 14, wherein to transmit the communication, said processor is configured to transmit the communication to a second user device corresponding to the second user.

16. The LT computing device of claim 14, wherein said processor is further configured to determine an occurrence within the plurality of communications corresponding to each dimension.

17. The LT computing device of claim 16, wherein to generate the personalized language model, said processor is configured to generate the personalized language model based on the corresponding occurrence of each dimension.

18. The LT computing device of claim 14, wherein the communication is an advertisement.

19. The LT computing device of claim 14, wherein to code the collected plurality of communications, said processor is configured to code the collected plurality of communications based on at least one of word type, punctuation, grammar, and word categories in the plurality of communications.

20. The LT computing device of claim 14, wherein to code the collected plurality of communications, said processor is configured to code the collected plurality of communications based on at least one of word complexity, word length, text length, and text structure in the plurality of communications.
